(19) United States
(12) Patent Application Publication
(10) Pub. No.: US 2023/0022430 A1
(43) Pub. Date: Jan. 26, 2023

(54) APPARATUS AND METHOD FOR SOLID PHASE EXTRACTION

(71) Applicant: GE HEALTHCARE LIMITED, Chalfont St. Giles Buckinghamshire (GB)

(72) Inventors: Graeme Walter MCROBBIE, Chalfont St. Giles Buckinghamshire (GB); Imtiaz Ahmed Khan, Chalfont St. Giles Buckinghamshire (GB); Jonathan Robert SHALES, Chalfont St. Giles Buckinghamshire (GB)

(73) Assignee: GE HEALTHCARE LIMITED, Chalfont St. Giles Buckinghamshire (GB)

(21) Appl. No.: 17/786,383

(22) PCT Filed: Dec. 17, 2020
(86) PCT No.: PCT/EP2020/086901

§ 371 Date: Jun. 16, 2022

(30) Foreign Application Priority Data
Dec. 20, 2019 (GB) 1919016.4

(51) Int. Cl. B01L 3/00

(52) U.S. Cl. CPC B01L 3/502; B01L 2200/0631; B01L 2400/06

(57) ABSTRACT

The present invention provides a cassette for determining optimised solid phase extraction (SPE) purification conditions, wherein said cassette comprises:
(i) a flowpath comprising a first end and a second end; and
(ii) a plurality of valves oriented along said flowpath, wherein each of said plurality of valves is selectively fluidly connected to one of a number of components, wherein said components comprise:
(a) 1-5 composition vials;
(b) 1-3 SPE cartridges;
(c) 4-10 solvent vials;
(d) a water vial; and
(e) a transfer line.

The present invention also provides a method for determining optimised SPE purification conditions for a compound from a composition, the method comprising:
(i) provision of a cassette as defined in any of claims 1 to 7;
(ii) the cassette comprising a composition of the compound in said composition vial(s) or addition of such a composition to said crude reaction vial(s);
(iii) passing an aliquot of said composition into each of said 1-3 SPE cartridges;
(iv) passing a particular combination of aliquots of solvent from at least 4 of said 4-10 solvent vials into one or more of the SPE cartridges, wherein the solvent in each of said 4-10 solvent vials is either a different solvent or the same solvent at different concentration;
(v) eluting the compound to be purified from the or each SPE cartridge;
(vi) evaluating the eluted products of step (v); and
(vii) determining the optimised purification conditions by comparing the eluted products of step (v) from each cartridge and each solvent.

The present invention relates to the field of solid phase extraction (SPE). More particularly, the present invention is directed to an apparatus and a method for optimising SPE conditions.

Automated synthesis systems are important for the production of radiopharmaceuticals. Synthesis systems, such as the FASTIab® synthesizer (GE Healthcare) provide for production of doses for clinical applications. The FASTIab synthesizer accepts and operates a method through a device for producing a radiopharmaceutical. Examples of such radiopharmaceuticals include ¹⁸F-FLT ([¹⁸F]fluorothymidine), ¹⁸F-FDDNP (2-(1-{6-[(2-[¹⁸F]fluoroethyl)(methyl)amino]2-naphthyl}ethylidene)malonitrile), ¹⁸F-FHBG (9-[4-[¹⁸F]fluoro-3-(hydroxymethyl)butyl]guanine or [¹⁸F]-penciclovir), ¹⁸F-FESP ([¹⁸F]-fluoroethylspiperone), ¹⁸F-p-MPPF (4-(2-methoxyphenyl)-1-[2-(N-2-pyridinyl)-p-[¹⁸F]fluorobenzamido]ethylpiperazine) and ¹⁸F-FDG ([¹⁸F]-2-deoxy-2-fluoro-D-glucose), and the like.

Such synthesis systems/devices are used with cassettes that comprise a flowpath comprising a first end and a second end; and a plurality of valves oriented along said flowpath, wherein each of said plurality of valves is selectively fluidly connected to one of a number of components, which typically include reagent vials, a reaction vessel where one or more reactions of the process of producing the compound are carried out, cartridges, filters, syringes, tubings, and connectors for synthesizing a particular radiotracer. Different radiopharmaceuticals are made using a dedicated cassette which is customized for that radiopharmaceutical. The device is configured to cooperatively engage the components so as to be able to actuate each of the stopcocks and syringes to drive a source fluid with a radioisotope through the device to achieve a chemical synthesis process. The synthesis system may also include one or more (e.g. two) heating cavity/heating elements which receives the first reaction vessel, so as to provide any heat required for chemical reactions.

The synthesis system is programmed to operate the required pumps, syringes, valves, heating elements, as well as controlling the provision of a motive gas (e.g. nitrogen) and the application of vacuum so as to direct the source fluid into mixing with the reagents, performing the chemical reactions, through the appropriate purification cartridges, and selectively pumping the output tracer and waste fluids into appropriate vial receptacles for end products, waste products, etc. While the fluid collected in the output vial is typically input into another system for either purification and/or dispensing, the synthesis system can also be connected to or include a separate purification system which returns a purified (or part purified compound) back to the system for further processing.

Such an automated synthesizer of the prior art is described in WO 2007/042781.

While existing synthesis systems such as the FASTIab synthesizer may include some form of purification step, the system is not deigned to, nor does it, optimise purification conditions. Purification methods such as those used in the prior art (for example FASTIab systems) are currently optimised using existing SPE manifold systems, where the SPE is carried out manually. It is time consuming to determine an appropriate purification method this way, as it typically involves manufacture of a product each time, followed by a different purification parameter, or parameters. In addition, once appropriate purification conditions have been identified, the resulting purification method needs further adaptations and optimization in order to be compatible with the synthesis system.

There are numerous examples of SPE robots available on the market. A key benefit of using the present invention is that it allows SPE purification methods to be quickly developed using already existing production devices. The time taken to transfer a SPE method onto existing devices (e.g., the FASTIab) is effectively eliminated because the backbone device can be the same for both.

Existing SPE robots are designed to collect larger fractions than generally used in the present invention. The ability to collect smaller fractions of eluent for analysis is an improvement on current SPE robots. The larger the collected fraction, the less that can be deduced about where the impurity/product is eluting.

In addition, existing SPE robots take up a large footprint in the lab. The present invention provides the advantage that an additional piece of equipment dedicated to SPE optimization is not needed where the lab already has an automated synthesis system.

For example, the cassette of the present invention can be used in conjunction with a FASTIab system that has been programmed to assess up to three SPE cartridges with up to 6 different mobile phases in one sequence. Furthermore, this provides the advantage that the cartridges can be re-used, allowing them to be tested repeatedly, which saves both in terms of time and cost of cartridges.

It would be beneficial if a process to optimise purification of the product could be developed to reduce the timescales as described above, and that is compatible with current synthesiser systems.

The present invention provides a device for optimising the SPE purification conditions for the isolation of a compound from a composition containing that compound, preferably from a crude reaction mixture. The compound to be isolated from the composition may be any radioactive or non-radioactive compound, preferably not a radioactive compound. The apparatus of the first aspect of the invention is described as a cassette. Such a cassette can be an independent piece of apparatus and/or can be a piece of apparatus which fits into an already existing apparatus, replacing some of the original parts.

In a first aspect, the present invention provides a cassette for determining optimised solid phase extraction (SPE) purification conditions, wherein said cassette comprises:
(i) a flowpath comprising a first end and a second end; and
(ii) a plurality of valves oriented along said flowpath, wherein each of said plurality of valves is selectively fluidly connected to one of a number of components,
wherein said components comprise:
(a) 1-5 composition vials;
(b) 1-3 SPE cartridges;
(c) 4-10 solvent vials;
(d) a water vial; and
(e) a transfer line.

The cassette of the invention has a flowpath comprising a first end and a second end. The flowpath is a channel that is suitable for transporting materials, particularly fluids, such as solvents and the composition, e.g. the crude reaction mixture. The composition vials may be crude reaction mixture vials, single reference standard vials or reference standard mixture vials. The ‘crude reaction mixture’ may include the desired product in a mixture with one or more impurities. The ‘single reference standard’ may be a single impurity, e.g. an impurity that is commonly produced with the desired product. Similarly, the ‘reference standard mixture’ may be a mixture of impurities, e.g. a mixture of impurities that are commonly produced with the desired product.

By ‘fluidly connected’, it is meant that fluid can pass into and from the vials and (selectively) through the valves to other parts of the cassette. A suitable valve may be a 3-way valve having three ports and means to put any two of the three associated ports in fluid communication with each other while fluidly isolating the third port. A suitable valve may also be a stopcock valve comprising a rotatable stopcock.

The cassette may be joined to, or compatible with, a system or device for synthesis of the compound for which the cassette of the invention is provided, for example the known FASTIab system. The cassette of the present invention is compatible with the synthesizer system used for radiopharmaceutical synthesis, as described above, and is specifically configured to optimise SPE purification conditions. The present invention thus allows the determination of an optimised SPE purification process for a product on the same system and/or a compatible system as is used for the production of that product. This provides clear advantages over existing methods. For example, because the purification process is optimised on the same or a compatible system as used for the production of the desired product, no further adaptation is needed for the purification process to work on that system, in contrast with existing methods.

The cassette is designed such that it provides a combination of SPE cartridges on one hand with solvent vials providing different solvents (either different chemical compositions or different concentrations) and on the other hand, to provide an apparatus where alternative parameters of SPE and solvent are available and combined to determine an optimum purification process.

Preferably, the cassette comprises:
(i) 3 SPE cartridges and 6 solvent vials; or
(ii) 2 SPE cartridges and 8 solvent vials; or
(iii) 1 SPE cartridge and 10 solvent vials.

One of the solvent vials may be used to condition the SPE cartridge(s). The conditioning may be carried out by passing 100% solvent through the SPE cartridge, followed by passing water through the SPE cartridge. In this case, the number of solvent vials used for purification can be regarded as 5 solvent vials for 3 SPE cartridges, 7 solvent vials for 2 SPE cartridges and 9 solvent vials for 1 SPE cartridge.

In one embodiment the cassette of the invention does not include any means for processing radio isotopes, e.g. [¹⁸F]fluoride. For example, the cassette does not include an ‘ion-exchange cartridge’, e.g., an SPE cartridge that retains ¹⁸F and allows ¹⁸O to pass through when an aqueous solution from the nuclear reaction ¹⁸O(p,n)¹⁸F is passed through. Such ion-exchange cartridges include anion exchange cartridges, for example quaternary methylammonium (QMA) cartridges, and these are typically found in known cassettes designed for radiosynthesis of radiolabelled compounds. In one embodiment the cassette also does not include a ‘cationic counterion’, where the cationic counterion may be a positively-charged counterion such as a metal complex of a cryptand or a tetraalkylammonium salt or a large but soft metal ion such as rubidium or caesium.

In one embodiment the cassette does not include a reaction vessel.

The cassette may have 25 valves in a linear array. Where the cassette has 25 valves in a linear array and the cassette comprises 3 SPE cartridges and 6 solvent vials,
(i) the 1-5 composition vials are fluidly connected to the 2^{nd}, 12^{th}, 13^{th}, 14^{th} and/or 16^{th} valve, preferably wherein a maximum of 3 composition vials are used;
(ii) the 3 SPE cartridges are preferably fluidly connected to the 18^{th}, 20^{th} and 22^{nd} valves;
(iii) the 6 solvent vials are fluidly connected to the 4^{th}, 5^{th}, 7^{th}, 8^{th}, 9and 10^{th} valves; and
(iv) the water vial is fluidly connected to the 15^{th} valve.

Where the cassette has 25 valves in a linear array and the cassette comprises 2 SPE cartridges and 8 solvent vials,
(i) the 1-5 composition vials are fluidly connected to the 2^{nd}, 12^{th}, 13^{th}, 14^{th} and/or 16^{th} valve, preferably wherein a maximum of 2 composition vials are used;
(ii) the 2 SPE cartridges are preferably fluidly connected to the 20^{th} and 22^{nd} valves;
(iii) the 8 solvent vials are fluidly connected to the 4^{th}, 5^{th}, 7^{th}, 8^{th}, 9^{th}, 10^{th}, 17^{th} and 18^{th} valves; and
(iv) the water vial is fluidly connected to the 15^{th} valve.

Where the cassette has 25 valves in a linear array and the cassette comprises 1 SPE cartridge and 10 solvent vials,
(i) the 1-5 composition vials are fluidly connected to the 2^{nd}, 12^{th}, 13^{th}, 14^{th} and/or 16^{th} valve, preferably wherein a maximum of 1 composition vial is used;
(ii) the 1 SPE cartridge is preferably fluidly connected to the 22^{nd} valve;
(iii) the 10 solvent vials are fluidly connected to the 4^{th}, 5^{th}, 7^{th}, 8^{th}, 9^{th}, 10^{th}, 17^{th}, 18^{th}, 19^{th} and 20^{th} valves; and
(iv) the water vial is fluidly connected to the 15^{th} valve.

The cassette described above may further comprise:
(v) a syringe fluidly connected to the 3^{rd} valve, preferably wherein the syringe is a 1 mL syringe; and
(vi) a syringe fluidly connected to the 11^{th} valve, preferably wherein the syringe is a 7 mL syringe; and
(vii) a syringe fluidly connected to the 24^{th} valve, preferably wherein the syringe is a 7 mL syringe.

The cassette described above may further comprise:
(viii) tubing connecting the 1^{st} and 25^{th} valves.

The cassette described above may further comprise:
(ix) an output for eluent from the SPE cartridge(s) fluidly connected to the 23^{rd} valve.

In a second aspect of the invention, the present invention provides a method for determining optimised SPE purification conditions for a compound from a composition, the method comprising:
(i) provision of the cassette as defined according to the first aspect of the invention;
(ii) the cassette comprising a composition of the compound in each of said 1-5 composition vials or addition of such a composition to each of said 1-5 composition vials;
(iii) passing an aliquot of said composition into each of said 1-3 SPE cartridges;
(iv) passing a particular combination of aliquots of solvent from at least 4 of said 4-10 solvent vials into one or more of the SPE cartridges, wherein the solvent in each of said 4 -10 solvent vials is either a different solvent or the same solvent at different concentration;
(v) eluting the compound to be purified from the or each SPE cartridge;
(vi) evaluating the eluted products of step (v); and
(vii) determining the optimised purification conditions by comparing the eluted products of step (v) from each cartridge and each solvent.

The at least one solvent is selected from the group consisting of: (i) ethanol, (ii) methanol, (iii) acetonitrile, or any alternative organic solvent known in the art, or combinations thereof. It is preferred that the product be eluted with ethanol or aqueous ethanol, because if a different solvent is used, an aqueous solvent exchange step would need to be included.

The method may further comprise the step of conditioning the 1-3 SPE cartridges as a first step of the process. The cartridges may be conditioned with 100% organic solvent (either methanol, ethanol or acetonitrile), followed by conditioning with water. The volume of organic solvent and water used for conditioning can be varied to suit different cartridges. For example, 7 mL of organic solvent and 7 mL of water can be suitable. Or a smaller volume of organic solvent can be suitable, e.g. 2 mL, and in this case multiple cartridges can be conditioned using solvent from just one syringe. In one embodiment a full syringe of water is used to ensure the solvent is completely removed. Following conditioning, the crude product is loaded onto the SPE cartridge(s).

Each cartridge is then washed with mobile phase eluent in fractions in variable volumes, where the volume is a compromise between “more detail” i.e. smaller volumes and “analysis time” i.e. the smaller the volumes collected the more samples need to be analysed. The fraction volume is preferably 1 mL. The eluent fractions are collected and analysed, e.g. by analytical HPLC. The cartridges can be cleaned with 100% organic solvent and reconditioned ready to be used again with a different mobile phase composition during the process. To minimise operator processing time, the samples can be collected in a 96-well plate and analysed on a HPLC system that uses an autosampler injection system. The collected samples can be analysed overnight and then the results interpreted the following morning. The evaluation in step (vi) may be performed using any suitable method, for example, HPLC, LC-MS or TLC.

1, 2, 3, 4 or 5 composition vials may be used. In particular, 1, 2 or 3 composition vials may be used. Preferably, the number of composition vials may be the same as the number of SPE cartridges.

The term ‘eluting’ refers to passing a solution through an SPE cartridge with the aim to release a compound or compounds of interest that has or have been bound to the solid phase. Eluting may be carried out by passing a suitable solvent through the SPE cartridge and through the transfer line for collection, preferably wherein the collection is in a 96-well plate. The suitable solvent is one that acts to release the compounds of interest from the SPE cartridge and can be, for example, an organic solvent, an acidic solvent, or a basic solvent depending on the chemical properties of the compound of interest and the nature of the SPE column chemistry.

The above method may further comprise the step of eluting impurities. The elution of the impurities may be carried out before and/or after step (v) above of eluting the desired product. Preferably, the elution of the impurities may be carried out before and after step (v) above of eluting the desired product.

The purification process is ideally effective if the product obtained from the composition is obtained in a purity of at least 95%, preferably at least 97%, more preferably at least 99%.

The invention also provides a compound as purified according to the second aspect of the invention.

In a third aspect, the invention provides a kit comprising:
(i) a cassette according to the first aspect,
(ii) 1-5 composition vials;
(iii) 1-3 SPE cartridges;
(iv) 4-10 solvent vials;
(v) a water vial; and
(vi) a transfer line.

### FIGURES

FIGS. 1 to 6 are provided to exemplify the invention in a non-limiting fashion:

FIG. 1 provides an example of an embodiment of the cassette of the invention including 3 SPE cartridges and 6 solvent vials (labelled as mobile phases).

FIG. 2 provides an example of an embodiment of the cassette of the invention including 2 SPE cartridges and 8 solvent vials (labelled as mobile phases).

FIG. 3 provides an example of an embodiment of the cassette of the invention including 1 SPE cartridge and 10 solvent vials (labelled as mobile phases).

FIG. 4 provides an example of a cassette that is typically used with a FASTIab system for comparison with the invention.

FIG. 5 shows the results of an embodiment of the method of the invention applied to a hydroxy impurity in the Flurpiridaz crude product.

FIG. 6 shows the results of an embodiment of the method of the invention applied to a crude reaction mixture of Flurpiridaz. In FIG. 6, the x axis is the volume (1-41 ml) and the y axis is ug (0-25).

### EXAMPLES

The following examples describe the invention in a non-limiting fashion:

The first experiments were done using crude samples comprising the compound GE-179 with mobile phase consisting of 20, 30 and 40% ethanol in 0.1% aqueous formic acid solution. The structure of GE-179 is as follows:

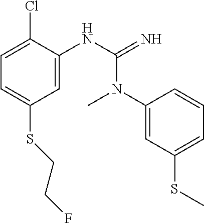 [SMILES: CSc1cccc(N(C)C(=N)Nc2cc(SCCF)ccc2Cl)c1]

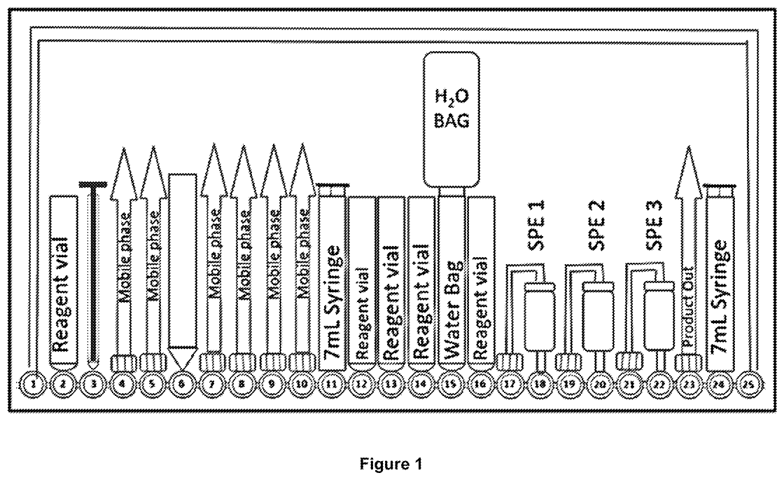

The FASTIab cassette was set-up as shown in FIG. 1. All 3 cartridges were conditioned with 100% ethanol (2 mL) followed by 100% water (7 mL). Crude product (dissolved in 10% ethanol 90% water) was loaded onto 3×tC18 cartridges. The first cartridge was washed with 20% ethanol, the second with 30% ethanol and the third with 40% ethanol (18 mL through each, 1 mL fractions collected). 54 samples were collected in a 96 well plate and analysed using an analytical HPLC system with an autosampler. The data generated showed that with 40% EtOH, everything got eluted from the cartridge in the first 6 mL, whereas with 20%, the desired product and all later eluting peaks were trapped on the cartridge after 18 mL wash. These results reveal that the optimum conditions for washing the cartridge would be greater than 20% but lower than 40% EtOH. Further experiments using the same technique are required to determine the optimum selective elution of the product.

Experiments were also performed directed to the purification of Flurpiridaz, which has the following structure:

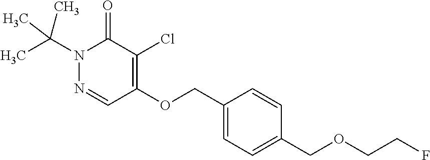 [SMILES: CC(C)(C)n1ncc(OCc2ccc(COCCF)cc2)c(Cl)c1=O]

The main impurity in the Flurpiridaz crude product is a hydroxy impurity, which has the following structure:

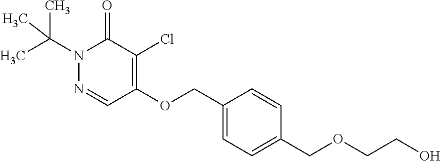 [SMILES: CC(C)(C)n1ncc(OCc2ccc(COCCO)cc2)c(Cl)c1=O]

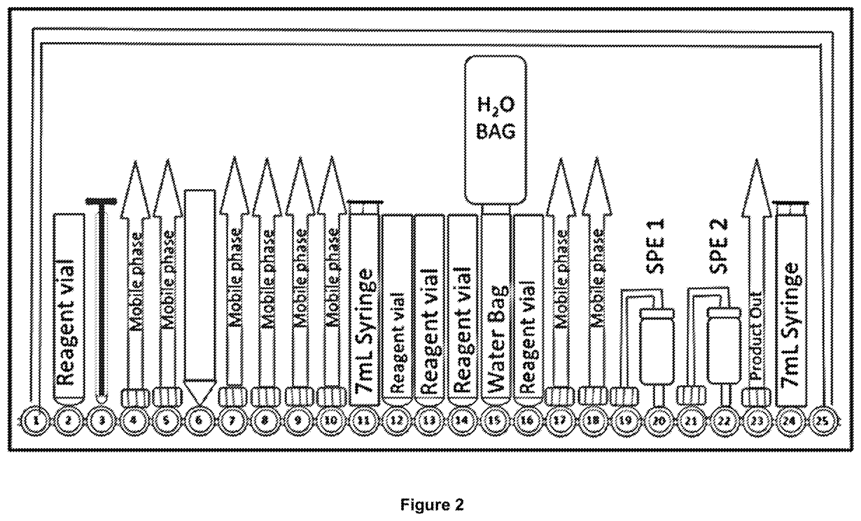

The FASTIab cassette was set up as shown in FIG. 2. Both cartridges were conditioned with 100% ethanol (7 mL) followed by 100% water (7 mL). The hydroxy impurity (dissolved in 1:10 ethanol:water) was loaded onto 2×tC18 cartridges. The first cartridge was washed with 40% acetonitrile and the second with 35% ethanol (41 mL through each, 1 mL fractions collected). 82 samples were collected in a 96 well plate and analysed using an analytical HPLC system with an autosampler.

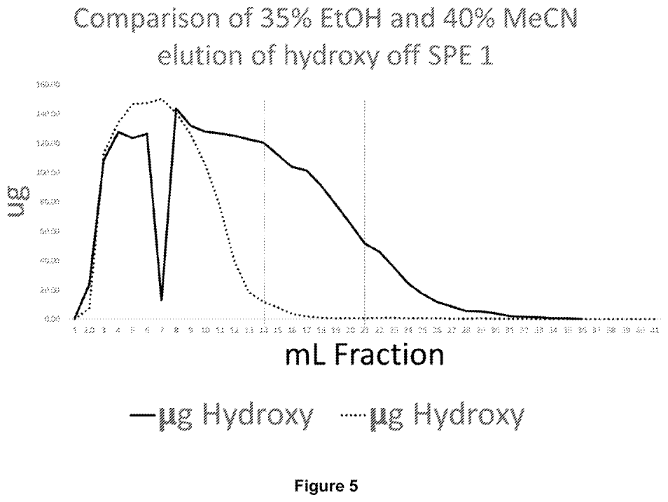

FIG. 5 shows that the hydroxy impurity elutes in a tighter band with 40% acetonitrile (dotted line) compared to 35% ethanol (solid line). These results confirmed that 40% acetonitrile is better than 35% ethanol and that a wash volume of 14-21 mL was sufficient to remove the major impurity from the crude product. It is noted that the line in FIG. 5 corresponding to the 35% ethanol elution includes a sharp dip, which is due to an erroneous data point.

The experiment was repeated with a crude reaction mixture of Flurpiridaz:

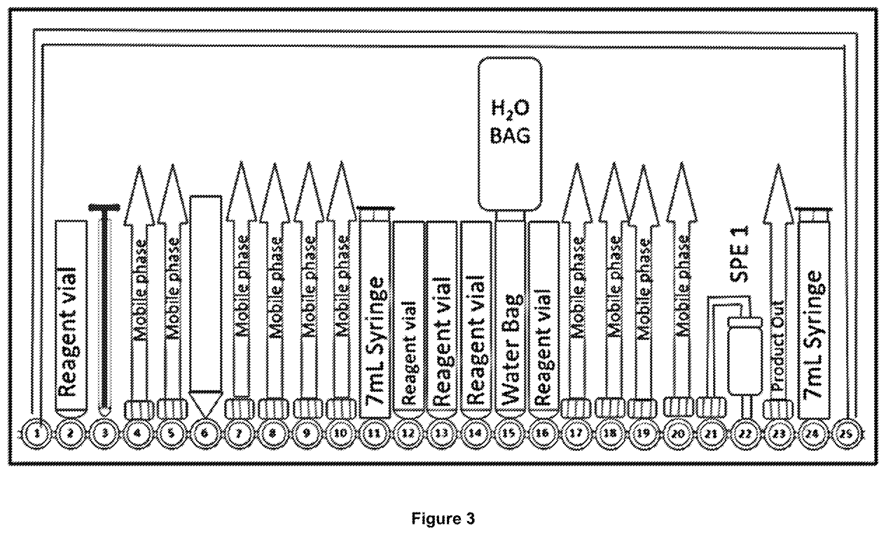

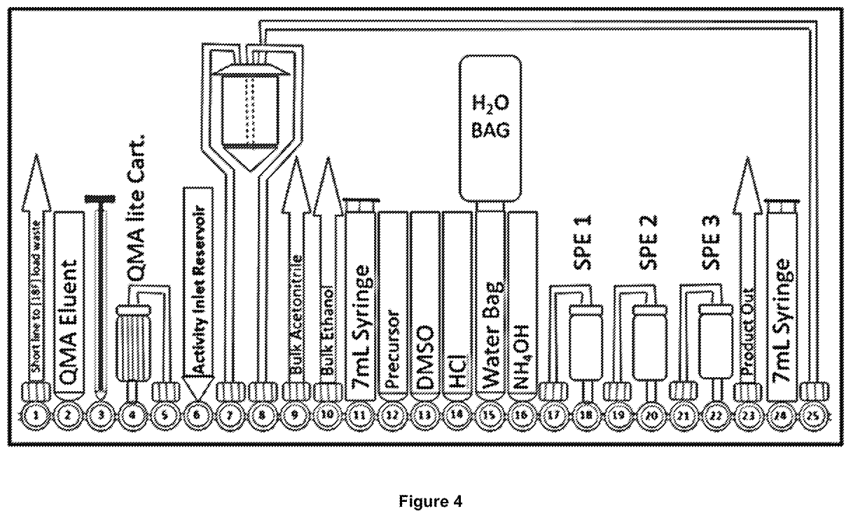

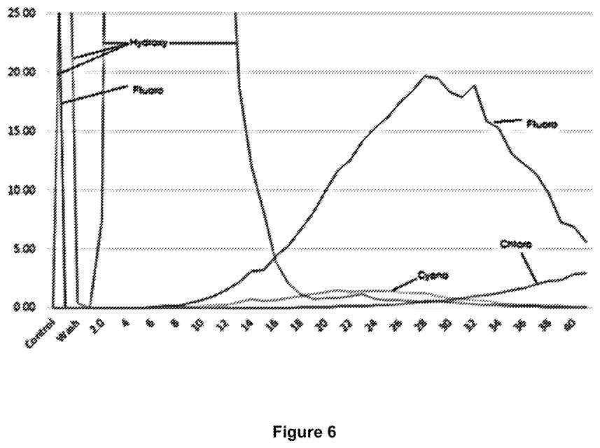

The FASTIab cassette was set-up as shown in FIG. 3. The cartridge was conditioned with 100% ethanol (7 mL) followed by 100% water (7 mL). Crude product (dissolved in ca.20% acetonitrile 80% aqueous solution) was loaded onto a tC18 cartridge. The cartridge was washed with 40% acetonitrile (41 mL, 1 mL fractions collected). 41 samples were collected in a 96 well plate and analysed using an analytical HPLC system with an autosampler. When combined with the information from the hydroxy standard experiment above, these results, shown in FIG. 6, confirmed that a wash volume of ca. 16 mL was sufficient to remove the hydroxy impurity without eluting the product. Other impurities present in very small amounts were a cyano impurity and a chloro impurity.

It will be readily understood by those persons skilled in the art that the embodiments of the inventions described herein are capable of broad utility and application. Accordingly, while the invention is described herein in detail in relation to the exemplary embodiments, it is to be understood that this disclosure is illustrative and exemplary of embodiments and is made to provide an enabling disclosure of the exemplary embodiments. The disclosure is not intended to be construed to limit the embodiments of the invention or otherwise to exclude any other such embodiments, adaptations, variations, modifications and equivalent arrangements. The scope of the invention is defined by the appended claims.

1. A cassette for determining optimised solid phase extraction (SPE) purification conditions, wherein said cassette comprises:
(i) a flowpath comprising a first end and a second end; and
(ii) a plurality of valves oriented along said flowpath, wherein each of said plurality of valves is selectively fluidly connected to one of a number of components, wherein said components comprise:
(a) at least one composition vial;
(b) 1-3 SPE cartridges;
(c) 4-10 solvent vials;
(d) a water vial; and
(e) a transfer line.

2. The cassette of claim 1, wherein the cassette does not include any means for processing [¹⁸F]fluoride.

3. The cassette of claim 1, wherein the cassette is selected from cassettes (I), (II), or (III):
(I) 3 SPE cartridges and 6 solvent vials; or
(II) 2 SPE cartridges and 8 solvent vials; or
(III) 1 SPE cartridge and 10 solvent vials.

4. The cassette of claim 3, part (i), wherein the cassette is cassette (I), and has 25 valves in a linear array, and
(i) the at least one composition vials are fluidly connected to the 2^{nd}, 12^{th}, 13^{th}, 14^{th} and/or 16^{th} valve;
(ii) the 3 SPE cartridges are fluidly connected to the 18^{th}, 20^{th} and 22^{nd} valves;
(iii) the 6 solvent vials are fluidly connected to the 4^{th}, 5^{th}, 7^{th}, 8^{th}, 9^{th} and 10^{th} valves; and
(iv) the water vial is fluidly connected to the 15^{th} valve.

5. The cassette of claim 3, part (ii), wherein the cassette is cassette (II), and has 25 valves in a linear array, and
(i) the at least one composition vials are fluidly connected to the 2^{nd}, 12^{th}, 13^{th}, 14^{th} and/or 16^{th} valve;
(ii) the 2 SPE cartridges are fluidly connected to the 20^{th} and 22^{nd} valves;
(iii) the 8 solvent vials are fluidly connected to the 4^{th}, 5^{th}, 7^{th}, 8^{th}, 9^{th}, 10^{th}, 17^{th} and 18^{th} valves; and
(iv) the water vial is fluidly connected to the 15^{th} valve.

6. The cassette of claim 3, wherein the cassette is cassette (III), and has 25 valves in a linear array, and (i) the at least one composition vials are fluidly connected to the 2^{nd}, 12^{th}, 13^{th}, 14^{th} and/or 16^{th} valve;
(ii) the 1 SPE cartridge is fluidly connected to the 22^{nd} valve;
(iii) the 10 solvent vials are fluidly connected to the 4^{th}, 5^{th}, 7^{th}, 8^{th}, 9^{th}, 10^{th}, 17^{th}, 18^{th}, 19^{th} and 20^{th} valves; and
(iv) the water vial is fluidly connected to the 15^{th} valve.

7. The cassette of claim 4, wherein the cassette further comprises:
(i) a syringe fluidly connected to the 3^{rd} valve; and
(ii) a syringe fluidly connected to the 11th valve; and
(iii) a syringe fluidly connected to the 24^{th} valve.

8. A method for determining optimised SPE purification conditions for the isolation of a compound from a composition, the method comprising:
(i) provision of the cassette of claim 1;
(ii) the cassette comprising a composition of the compound in each of said at least one composition vials or addition of such a composition to each of said at least one composition vials;
(iii) passing an aliquot of said composition into each of said 1-3 SPE cartridges;
(iv) passing a particular combination of aliquots of solvent from at least 4 of said 4-10 solvent vials into one or more of the SPE cartridges, wherein the solvent in each of said 4-10 solvent vials is either a different solvent or the same solvent at different concentration;
(v) eluting the compound to be purified from the or each SPE cartridge;
(vi) evaluating the eluted products of step (v); and
(vii) determining the optimised purification conditions by comparing the eluted products of step (v) from each cartridge and each solvent.

9. The method of claim 8, wherein the method further comprises a step of eluting impurities.

10. The method of claim 8, wherein the at least one solvent is selected from: (i) ethanol, (ii) methanol, (iii) acetonitrile, or combinations thereof.

11. The method of claim 8, wherein the method further comprises a step of conditioning the 1-3 SPE cartridges before step (ii).

12. The method of claim 8, wherein the evaluation in step (vi) is performed using HPLC, LC-MS or TLC.

13. The method of claim 8, wherein the eluting is carried out by passing organic solvent through the SPE cartridge and through the transfer line for collection.

14. The cassette of claim 1, wherein the at least one composition vials are:
(i) at least one crude reaction mixture vials;
(ii) at least one single reference standard vials; or
(iii) at least one reference standard mixture vials.

15. A kit comprising:
(i) the cassette as defined in claim 1,
(ii) at least one composition vials;
(iii) 1-3 SPE cartridges;
(iv) 4-10 solvent vials;
(v) a water vial; and
(vi) a transfer line.

16. The cassette of claim 4, wherein a maximum of 3 composition vials are used.

17. The cassette of claim 5, wherein a maximum of 2 composition vials are used.

18. The cassette of claim 6, wherein a maximum of 1 composition vial is used.

19. The method of claim 9, wherein the step of eluting impurities is carried out before and/or after step (v).

20. The method of claim 13, wherein the collection is in a 96 well plate.
